(19) United States
(12) Patent Application Publication
(10) Pub. No.: US 2026/0261382 A1
(43) Pub. Date: Sep. 3, 2026

(54) CSI REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US); Caleb K. Lo, San Jose, CA (US)

(21) Appl. No.: 19/067,787

(22) Filed: Feb. 28, 2025

Related U.S. Application Data
(60) Provisional application No. 63/566,090, filed on Mar. 15, 2024.
(60) Provisional application No. 63/760,325, filed on Feb. 19, 2025.

(51) Int. Cl. H04L 5/00; H04B 7/06; H04W 24/10

(52) U.S. Cl. CPC H04L 5/0051; H04B 7/0626; H04W 24/10

(57) ABSTRACT

Apparatuses and methods for channel state information (CSI) reporting. A method performed by a user equipment (UE) is provided. The method includes receiving a basis that is trained using data, and receiving information about a channel state information (CSI) report based on the basis. The information includes at least one parameter associated with the basis. The method further includes identifying the basis, determining the CSI report based on the basis and the information, and transmitting the CSI report. The basis, the data, and the CSI report are associated with P ports and N_{SB} subbands (SBs).

### CROSS-REFERENCE TO RELATED AND CLAIM OF PRIORITY

The present application claims priority under 35 U.S.C. § 119(e) to U.S. Provisional Patent Application No. 63/566,090 filed on Mar. 15, 2024 and U.S. Provisional Patent Application No. 63/760,325 filed on Feb. 19, 2025, which are hereby incorporated by reference in their entirety.

### TECHNICAL FIELD

The present disclosure relates generally to wireless communication systems and, more specifically, the present disclosure is related to apparatuses and methods for channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to CSI reporting.

In one embodiment, a user equipment (UE) is provided. The UE includes a transceiver configured to receive a basis that is trained using data and receive information about a channel state information (CSI) report based on the basis. The information includes at least one parameter associated with the basis. The UE further includes a processor operably coupled to the transceiver. The processor is configured to identify the basis and determine the CSI report based on the basis and the information. The transceiver is further configured to transmit the CSI report. The basis, the data, and the CSI report are associated with P ports and N_{SB} subbands (SBs).

In another embodiment, a base station (BS) is provided. The BS includes a processor and a transceiver coupled to the processor. The transceiver is configured to transmit a basis that is trained using data, transmit information about a CSI report based on the basis, the information including at least one parameter associated with the basis, and receive the CSI report that is associated with the basis and the information. The basis, the data, and the CSI report are associated with P ports and N_{SB} SBs.

In yet another embodiment, a method performed by a UE is provided. The method includes receiving a basis that is trained using data, and receiving information about a CSI report based on the basis. The information includes at least one parameter associated with the basis. The method further includes identifying the basis, determining the CSI report based on the basis and the information, and transmitting the CSI report. The basis, the data, and the CSI report are associated with P ports and N_{SB} SBs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of example radio access network (RAN) configurations according to embodiments of the present disclosure;

FIG. 7 illustrates a diagram of an example convolutional neural network (CNN) according to embodiments of the present disclosure;

FIG. 8 illustrates a diagram of an example antenna port layout according to embodiments of the present disclosure;

FIG. 9 illustrates a timeline of example spatial-domain (SD) units and frequency-domain (FD) units according to embodiments of the present disclosure;

FIG. 10 illustrates a diagram of an example two-sided model according to embodiments of the present disclosure;

FIG. 11 illustrates a flowchart of an example procedure for parameterizing basis-related information according to embodiments of the present disclosure;

FIG. 12 illustrates a flowchart of an example procedure for parameterizing basis-related information according to embodiments of the present disclosure; and

FIG. 13 illustrates an example method performed by a UE in a wireless communication system according to embodiments of the present disclosure.

### DETAILED DESCRIPTION

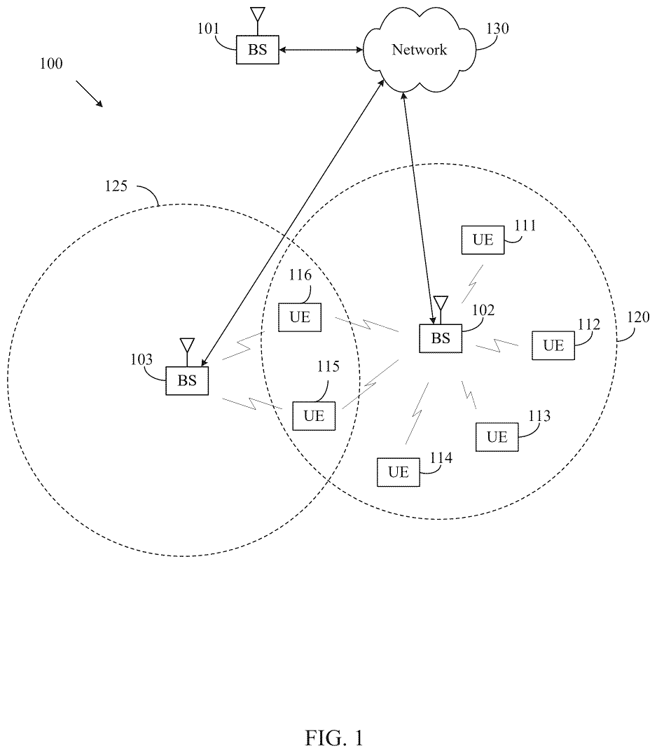

FIGS. 1-13 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP, TS 38.211, 5G; NR; Physical channels and modulation; [REF2] 3GPP, TS 38.331, 5G; NR; Radio Resource Control (RRC); Protocol specification; [REF3] 3GPP, TS 38.321, 5G; NR; Medium Access Control (MAC); Protocol specification; [REF4] 3GPP, TS 38.214, 5G; NR; Physical layer procedures for data; [REF5] 3GPP TS 38.212 v18.0.0, “E-UTRA, NR, Multiplexing and Channel coding;” [REF6] 3GPP TS 38.213 v18.0.0, “E-UTRA, NR, Physical Layer Procedures for Control;” [REF7] O-RAN.WG4.CONF.0-R003-v09.00, “O-RAN Working Group 4 (Fronthaul Working Group) Conformance Test Specification;” and [REF8] O-RAN.WG4.CUS.0-R003-v13.00, “O-RAN Working Group 4 (Open Fronthaul Interfaces WG)—Control, User and Synchronization Plane Specification.”

FIGS. 1-13 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for CSI reporting. In certain embodiments, one or more of the BSs 101-103 include circuitry, programing, or a combination thereof to support CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

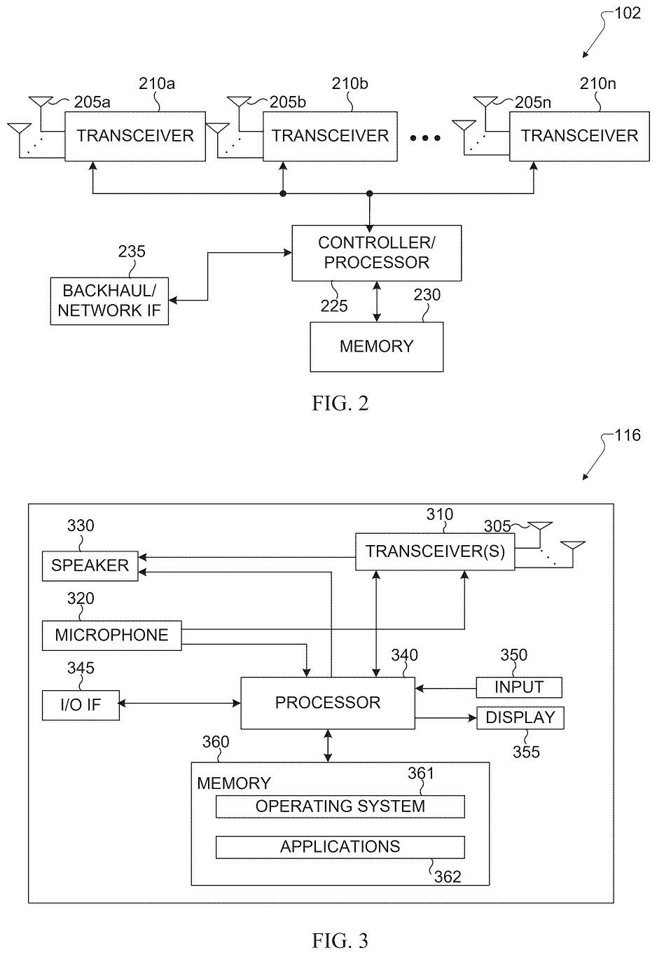

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI reporting. Any of a wide variety of other functions could be supported in the gNB 102 by the controller/processor 225.

The controller/processor 225 is also capable of executing programs and other processes resident in the memory 230, such as processes to support CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

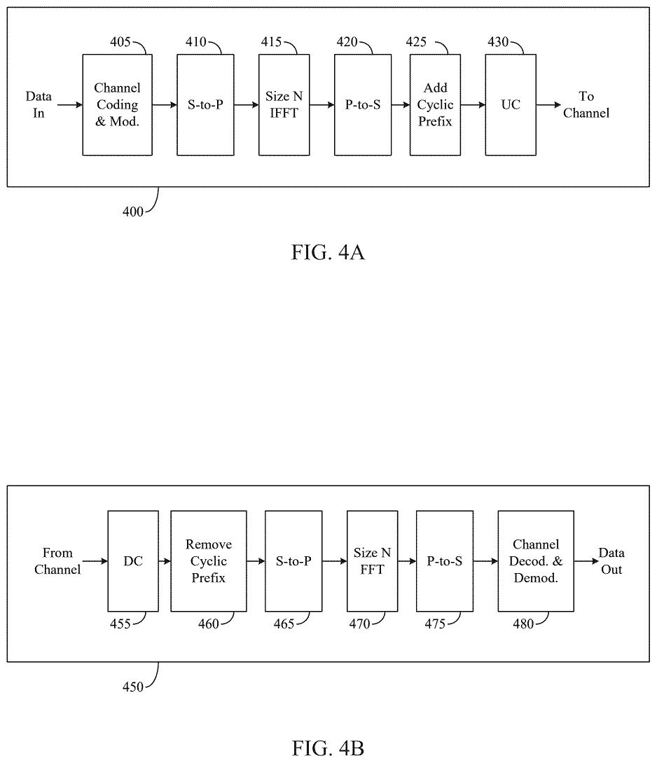

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

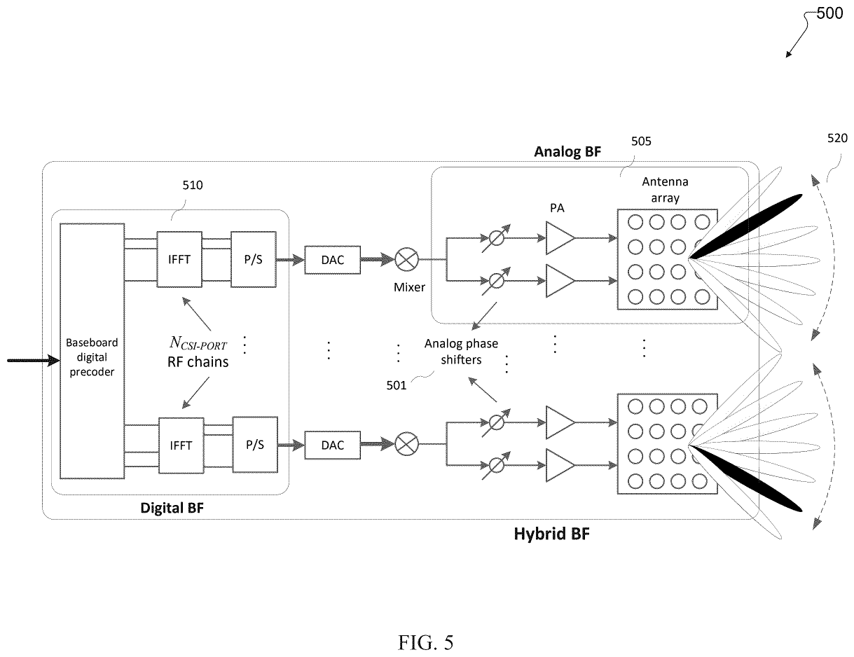

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication/information CSI reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed evaluating carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multiple user multiple-input-multiple-output (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

The present disclosure relates generally to wireless communication systems and, more specifically, to Deep-learning-based precoding in next generation of communication (e.g. 6G) systems.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below.

TABLE 0

| Frequency range | |
|---|---|
| designation | Corresponding frequency range |
| FR1 | 450 MHz-600 MHz |
| FR2 | 24250 MHz-52600 MHz |

For MIMO in FR1, up to 32 CSI-RS antenna ports is supported, and in FR2, up to 8 CSI-RS antenna ports is supported. In next generation cellular standards (e.g. 6G), in addition to FR1 and FR2, new carrier frequency bands can be considered, e.g., FR4 (>52.6 GHz), terahertz (>100 GHz) and upper mid-band (7-15 GHz), aka FR3. The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

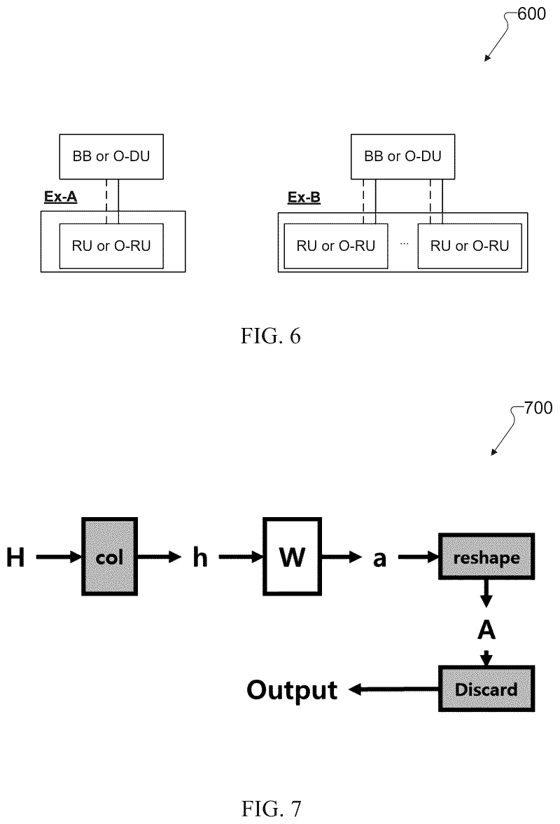

FIG. 6 illustrates a diagram of example RAN configurations 600 according to embodiments of the present disclosure. For example, RAN configurations 600 can be implemented by the BS 102 of FIG. 1. This example is for illustration only and other embodiments can be used without departing from the scope of the present disclosure.

Likewise, for O-RAN, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2×).
More than one RUs or O-RUs
One or more than one RUs or O-RUs

Two examples are shown in FIG. 6.

The following are defined in [REF7 and REF8].

| | |
|---|---|
| O-CU | O-RAN Central Unit-a logical node hosting PDCP, RRC, SDAP and other |
| | control functions |
| O-DU | O-RAN Distributed Unit: a logical node hosting RLC/MAC/High-PHY layers |
| | based on a lower layer functional split. O-DU in addition hosts an M-Plane |
| | instance. |
| O-RU | O-RAN Radio Unit: a logical node hosting Low-PHY layer and RF processing |
| | based on a lower layer functional split. This is similar to 3GPP's “TRP” or “RRH” |
| | but more specific in including the Low-PHY layer (FFT/iFFT, PRACH extraction). |
| | O-RU in addition hosts M-Plane instance. |

A typical network up to 5G network (NW) can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHz (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic/frequent update of the analog BF, which is often based on (analog) beam measurement and reporting.

A communication between the 5G NW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-)MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Assuming NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

A transmission configuration indication (TCI) framework is shared between (non-beam-related) CSI and beam management (BM). While the complexity of such a TCI framework is justified for CSI acquisition in FR1, it makes BM procedures less efficient in FR2. Furthermore, the BM procedures can be different for different channels due to their different target scenarios. Having different beam indication/update mechanisms increases the complexity, overhead, and latency of BM. Such drawbacks are especially troublesome for high mobility scenarios (such as highway and high-speed train). These drawbacks motivated a streamlined BM framework for beam-based operations and procedures that is common for data and control, and uplink (UL) and downlink (DL) channels. This framework is referred to as a unified TCI (uTCI) framework, firstly introduced for sTRP and now being enhanced for mTRP.

The uTCI framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

In 5G NR, a significant improvement in throughput can be obtained by supporting MU-MIMO transmission, where one gNB (e.g., the BS 102) simultaneously transmits multiple data streams to multiple UEs. MU-MIMO transmission relies on the availability of accurate DL CSI at the gNB; in frequency division duplexing (FDD) systems, each UE measures DL CSI and reports its measurements. Each CSI report can include precoding matrix indicator (PMI) (the dominant channel directions), RI (the number of dominant channel directions), and/or CQI (the best modulation and code rate that the channel can support).

The overhead of DL CSI increases with the number of antenna ports at the gNB and the number of SBs. Current 5G systems support tens of SBs and a maximum of 32 antenna ports at the gNB. Each UE uses pre-defined codebooks (e.g. Type I and Type II) for compressing DL CSI before it is reported to the gNB. These codebooks exploit channel correlations in the spatial and frequency domains; the application of these codebooks has significantly reduced the overhead of DL CSI feedback. In Release-18, these codebooks are extended to exploit channel correlations in the temporal domain; the application of these codebooks could yield additional reductions in the overhead of DL CSI feedback.

The number of antenna ports at the gNB and the number of SBs are expected to increase for future systems to meet more stringent performance requirements-yet the overhead reduction from pre-defined codebooks may not scale accordingly (e.g. Type I and Type II codebooks utilize a DFT basis, which may not be applicable to future antenna configurations).

Besides, 5G NR codebooks (CBs) compress the CSI in the spatial/angle (introduced in Rel-15), frequency/delay (introduced in Rel-16), and time/Doppler (introduced in Rel-18) domains. The 5G NR CBs employ DFT basis vectors-based compression exploiting the sparsity of the channel (fewer significant coefficients) in certain domain (angle/delay/Doppler), DFT basis vectors-based representation of precoding vectors is computationally advantageous, e.g., O(n²) complexity for basis matrix inversion. Accordingly, embodiments of the present disclosure recognize that basis vectors-based representation may incur a non-trivial approximation error due to incomplete basis representation, fixed basis sampling, fixed (RRC-configured) number of basis vectors, etc. An example in which the channel strength in the spatial-frequency domain and angel-delay domain for a single layer precoding vectors (32 ports and 13 subbands) is provided. Rel-16 eType II codebook exploits the sparsity of the strong angle-delay coefficients for feedback overhead reduction, i.e., e.g., reports coefficients, say, corresponding to L=4 angle (beam) per polarization and M=3 delay components (basis vectors). The components, which are still significant but not reported by the eType II-based CSI feedback, contribute to the performance (accuracy) gap from the ideal feedback.

FIG. 7 illustrates a diagram of an example CNN according to embodiments of the present disclosure. For example, CNN 700 can be implemented by any of the UEs 111-116 of FIG. 1. This example is for illustration only and other embodiments can be used without departing from the scope of the present disclosure.

Evaluating the issues mentioned herein with 5G NR (DFT-based fixed) CBs, it may be advantageous to configure a UE (e.g., the UE 116) to support alternate methods of compressing DL CSI. For instance, deep-learning or AI/ML-based CSI feedback can provide better accuracy-overhead trade-off via non-linear compression. The following are the benefits of AI/ML-based CSI feedback.
Better performance, i.e., CSI feedback accuracy-overhead trade-off
Antenna panels/arrangements agnostic as opposed to the limitation of NR CBs to ULA
Better flexibility to support variable CSI feedback payload size
Capability to scale with a larger CSI dimensions (large number of ports, SD/FD/TD granularities, etc.)

For example, an AI/ML model architecture can be designed to train an autoencoder for generating/reporting CSI feedback, where the encoder utilizes a single CNN layer. When this trained autoencoder is used for inference, applying this CNN layer is equivalent to pre-multiplying its input by a Toeplitz (or doubly-block Toeplitz, circulant, doubly-block circulant, concatenation of doubly-block Toeplitz/circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix. In addition, 3-D linear convolution is equivalent to pre-multiplication by a matrix that includes a concatenation of doubly-block Toeplitz matrices.

An example is shown in FIG. 7 for a single layer CNN, where the Kernel is a vector/matrix (e.g. a vector if learning/training is only SD, and a matrix if it is on both SD and FD). The Convolution is equivalent to the following:
Create column vector from input H, i.e. h
a=W*h (where W is a Kernel matrix/vector based on doubly-block Toeplitz)
   Zero-pad kernel to create W
Reshape a to matrix A
   For each row in A, discard entries from partial kernel overlap with H

The W is essentially a Toeplitz matrix when the Kernel is a vector, and a doubly Toeplitz matrix when the Kernel is a matrix. A Toeplitz matrix [5] has constant (same) values along its negative-sloping diagonals; an example is shown in (1) as values . . . , a₋₁, a₀, a₁, . . . .

$$A = [ \begin{matrix}{a}_{0} & {a}_{− 1} & {a}_{− 2} & ⋯ & {a}_{− n + 1} \\ {a}_{1} & {a}_{0} & {a}_{− 1} & ⋱ & ⋮ \\ {a}_{2} & {a}_{1} & {a}_{0} & ⋱ & {a}_{− 2} \\ ⋮ & ⋱ & ⋱ & ⋱ & {a}_{− 1} \\ {a}_{n − 1} & ⋯ & {a}_{2} & {a}_{1} & {a}_{0}\end{matrix} ] \qquad ( 1 )$$

A doubly-block Toeplitz matrix is a block matrix R where 1) its (i,j)-th block Rᵢⱼ is a function of i−j (thus, it can be denoted by Rᵢ₋ⱼ) and 2) Rᵢⱼ (denoted by Rᵢ₋ⱼ) is itself a Toeplitz matrix. An example is shown in (2), where each Rⱼ is a Toeplitz matrix.

$$R = [ \begin{matrix}{R}_{0} & {R}_{− 1} & {R}_{− 2} & ⋯ & {R}_{− n + 1} \\ {R}_{1} & {R}_{0} & {R}_{− 1} & ⋱ & ⋮ \\ {R}_{2} & {R}_{1} & {R}_{0} & ⋱ & {R}_{− 2} \\ ⋮ & ⋱ & ⋱ & ⋱ & {R}_{− 1} \\ {R}_{n − 1} & ⋯ & {R}_{2} & {R}_{1} & {R}_{0}\end{matrix} ] \qquad ( 2 )$$

A circulant matrix is a special case of a Toeplitz matrix where each row (column) is a circular shift of the previous row (column). An example is shown in (3).

$$A = [ \begin{matrix}{a}_{0} & {a}_{− 1} & {a}_{− 2} & ⋯ & {a}_{− n + 1} \\ {a}_{− n + 1} & {a}_{0} & {a}_{− 1} & ⋱ & {a}_{− n + 2} \\ {a}_{− n + 2} & {a}_{− n + 1} & {a}_{0} & ⋱ & {a}_{− n + 3} \\ ⋮ & ⋱ & ⋱ & ⋱ & ⋮ \\ {a}_{− 1} & ⋯ & {a}_{− n + 2} & {a}_{− n + 1} & {a}_{0}\end{matrix} ] \qquad ( 3 )$$

A doubly-block circulant matrix is a special case of a doubly-block Toeplitz matrix R where 1) each block row (column) is a circular shift of the previous block row (column) and 2) its (i,j)-th block Rᵢⱼ (denoted by Rᵢ₋ⱼ) is itself a circulant matrix. An example is shown in (4), where each Rⱼ is a circulant matrix.

$$R = [ \begin{matrix}{R}_{0} & {R}_{− 1} & {R}_{− 2} & ⋯ & {R}_{− n + 1} \\ {R}_{− n + 1} & {R}_{0} & {R}_{− 1} & ⋱ & {R}_{− n + 2} \\ {R}_{− n + 2} & {R}_{− n + 1} & {R}_{0} & ⋱ & {R}_{− n + 3} \\ ⋮ & ⋱ & ⋱ & ⋱ & ⋮ \\ {R}_{− 1} & ⋯ & {R}_{− n + 2} & {R}_{− n + 1} & {R}_{0}\end{matrix} ] \qquad ( 4 )$$

Thus, using this trained autoencoder for inference is equivalent to applying a Toeplitz-based method for generating/reporting CSI feedback. This Toeplitz-based method can utilize a flexible basis that depends on a training dataset.

The present disclosure describes a framework for measurement aspects (data collection for model training and related signaling) supporting Toeplitz-based methods for generating/reporting CSI feedback.

Details on the support of Toeplitz-based methods for generating/reporting temporal-domain CSI feedback are disclosed, including information elements to be exchanged between a transmitter and a receiver. For the use case of CSI report, the following aspects are provided in the disclosure:
Measurement for data collection: both NW-side and UE-side measurement
Mode-Type: one-sided, two-sided
Mode transfer
Parameterized Toeplitz model

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure of disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

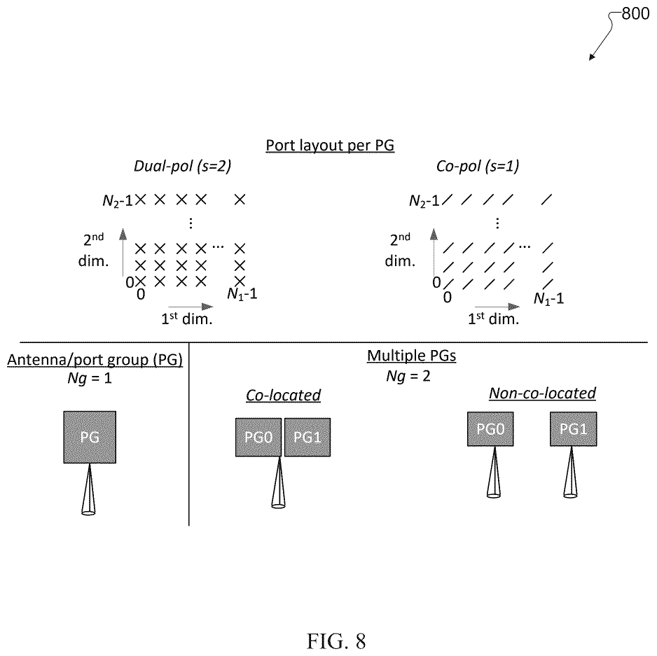

FIG. 8 illustrates a diagram of an example antenna port layout 800 according to embodiments of the present disclosure. For example, antenna port layout 800 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 8 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 8. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a nonzero power (NZP) CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-)configured more dynamically (e.g. via MAC CE or/and downlink control information (DCI)). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 8. The antenna structure at each PG or O-RU (or RU) can be the same. Or, the antenna structure at an PG or O-RU (or RU) can be different from another PG or O-RU (or RU). Likewise, the number of ports at each PG (OR O-RU OR RU) can be the same. Or, the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is expected in the rest of the disclosure. For simplicity, each PG (OR O-RU OR RU) is equivalent to a panel (cf. FIG. 8), although, an PG (OR O-RU OR RU) can have multiple panels in practice. The disclosure however is not restrictive to a single panel assumption at each PG (OR O-RU OR RU), and can easily be extended (covers) the case when an PG (OR O-RU OR RU) has multiple antenna panels.

In one embodiment, an PG (OR O-RU OR RU) constitutes (or corresponds to or is equivalent to) at least one of the following:
In one example, an PG OR O-RU (OR RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CSI-RS resource indicator (CRI) or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

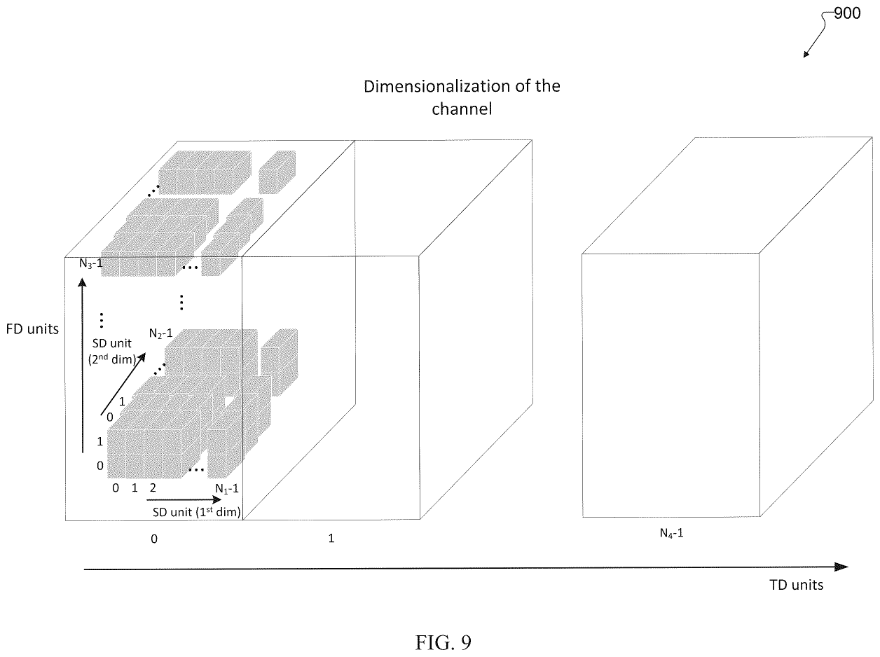

FIG. 9 illustrates a timeline 900 of example SD units and FD units according to embodiments of the present disclosure. For example, timeline 900 can be followed by any of the UEs 111-116 of FIG. 1, such as the UE 116. This example is for illustration only and other embodiments can be used without departing from the scope of the present disclosure.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 9.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG or O-RU (or RU) comprising P_{CSIRS} ports, and the CSI report is based on the channel measurement from the one PG or O-RU (or RU).
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG or O-RU (or RU) (one-to-one mapping). In one example, multiple CMRs can correspond to an PG or O-RU (or RU) (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or, it can be indicated via a MAC CE. Or, it can be provided via a DCI field.

Likewise, the value of K can be configured, e.g. via higher layer RRC parameter. Or, it can be indicated via a MAC CE. Or, it can be provided via a DCI field.

In one example, K=N_{g}=X. The value of X can be configured, e.g. via higher layer RRC parameter. Or, it can be indicated via a MAC CE. Or, it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

For illustrative purposes, a term “Toeplitz-based CSI feedback/report” is used to refer to a method for generating CSI reports that is based on a first component (or basis) W₁ which has a convolutional structure. For instance, the convolutional structure can correspond to a Toeplitz (or doubly-block Toeplitz, circulant, doubly-block circulant, concatenation of doubly-block Toeplitz/circulant) matrix. The CSI reports are based on a dual-stage precoding structure, where the first stage can correspond to the convolutional W₁ and the second stage can correspond to a second component (or coefficients) W₂. The overall precoding operation essentially can be expressed as W₁W₂, i.e., multiplication of a coefficient matrix (W₂) by a Toeplitz (or doubly-block Toeplitz, circulant, doubly-block circulant, concatenation of doubly-block Toeplitz/circulant) matrix (W₁). In this case, this Toeplitz (or doubly-block Toeplitz, circulant, doubly-block circulant, concatenation of doubly-block Toeplitz/circulant) matrix is analogous to the basis matrices W₁ and/or W_{f} and/or W_{d} or three sets of basis vectors (L vectors, Mᵥ or M vectors, and D vectors) as in the Type II codebooks (cf. 5.2.2.2.3/4/5/6/7/8/9/10/11, [4]) that perform compression in SD and/or FD and/or delay domain (DD)/time domain (TD), respectively.

If the convolutional structure of W₁ corresponds to a Toeplitz (or doubly-block Toeplitz, circulant, doubly-block circulant, concatenation of doubly-block Toeplitz/circulant) matrix, this Toeplitz (or doubly-block Toeplitz, circulant, doubly-block circulant, concatenation of doubly-block Toeplitz/circulant) matrix can be a square (e.g. n×n) matrix. This Toeplitz (or doubly-block Toeplitz, circulant, doubly-block circulant, concatenation of doubly-block Toeplitz/circulant) matrix can also be a tall (e.g. m×n, where m>n) or fat (e.g. n×m, where m>n) matrix.

Other terms that refer to a same method can also be used.

In one embodiment, for the space and temporal domains, the precoding matrix based on this disclosure has the following structure:

$$P = \frac{1}{γ} {W}_{1} {W}_{2} {W}_{d}^{H} = \frac{1}{γ} A C {A}_{d}^{H} = \frac{1}{γ} [ \begin{matrix}{a}_{0} & {a}_{− 1} & {a}_{− 2} & ⋯ & {a}_{− n + 1} \\ {a}_{1} & {a}_{0} & {a}_{− 1} & ⋱ & ⋮ \\ {a}_{2} & {a}_{1} & {a}_{0} & ⋱ & {a}_{− 2} \\ ⋮ & ⋱ & ⋱ & ⋱ & {a}_{− 1} \\ {a}_{n − 1} & ⋯ & {a}_{2} & {a}_{1} & {a}_{0}\end{matrix} ] {[ \begin{matrix}{c}_{0 , 0} & {c}_{0 , 1} & & {c}_{0 , m − 1} \\ ⋮ & ⋮ & ⋯ & ⋮ \\ {c}_{n − 1 , 0} & {c}_{n − 1 , 1} & & {c}_{n − 1 , m − 1}\end{matrix} ] [ \begin{matrix}{a}_{d , 0} & {a}_{d , − 1} & {a}_{d , − 2} & ⋯ & {a}_{d , − m + 1} \\ {a}_{d , 1} & {a}_{d , 0} & {a}_{d , − 1} & ⋱ & ⋮ \\ {a}_{d , 2} & {a}_{d , 1} & {a}_{d , 0} & ⋱ & {a}_{d , − 2} \\ ⋮ & ⋱ & ⋱ & ⋱ & {a}_{d , − 1} \\ {a}_{d , m − 1} & ⋯ & {a}_{d , 2} & {a}_{f , 1} & {a}_{d , 0}\end{matrix} ]}^{H} \qquad ( 7 )$$

where γ is a normalization factor. In one example, W₁ is an SD basis (e.g. across P_{CSIRS} CSI-RS antenna ports), and W_{d} is a DD/TD basis. The quantities a₋ₙ₊₁ . . . , a₋₁, a₀, a₁, . . . , aₙ₋₁ and/or a_{d,-m+1} . . . , a_{d,-1}, a_{d,0}, a_{d,1}, . . . , a_{d,m-1} in (7) can be configured to be determined by training an AI/ML model architecture. In another example, the quantities a₋ₙ₊₁ . . . , a₋₁, a₀, a₁, . . . , aₙ₋₁ and/or a_{d,-m+1} . . . , a_{d,-1}, a_{d,0}, a_{d,1}, . . . , a_{d,m-1} in (7) can be configured from a candidate set of quantities. In another example, the quantities a₋ₙ₊₁ . . . , a₋₁, a₀, a₁, . . . , aₙ₋₁ and/or a_{d,-m+1} . . . , a_{d,-1}, a_{d,0}, a_{d,1} . . . , a_{d,m-1} in (7) can be specified.

In a variation, the precoding matrix based on this disclosure has the following structure:

$$P = \frac{1}{γ} {W}_{1} {W}_{2} {W}_{d}^{H} = \frac{1}{γ} [ \begin{matrix}{A}_{1} & 0 \\ 0 & {A}_{2}\end{matrix} ] {CA}_{d}^{H} \qquad ( 8 )$$

where γ is a normalization factor. In one example, W₁ is an SD basis for two antenna groups (e.g. two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$\begin{matrix}P = \frac{1}{γ} {W}_{1} {W}_{2} = \frac{1}{γ} {A}_{s , d} C = \\ \frac{1}{γ} [ \begin{matrix}{a}_{s , d , 0} & {a}_{s , d , − 1} & {a}_{s , d , − 2} & ⋯ & {a}_{s , d , − n + 1} \\ {a}_{s , d , 1} & {a}_{s , d , 0} & {a}_{s , d , − 1} & ⋱ & ⋮ \\ {a}_{s , d , 2} & {a}_{s , d , 1} & {a}_{s , d , 0} & ⋱ & {a}_{s , d , − 2} \\ ⋮ & ⋱ & ⋱ & ⋱ & {a}_{s , d , − 1} \\ {a}_{s , d , n − 1} & ⋯ & {a}_{s , d , 2} & {a}_{s , d , 1} & {a}_{s , d , 0}\end{matrix} ] [ \begin{matrix}{c}_{0 , 0} & {c}_{0 , 1} & & {c}_{0 , m − 1} \\ ⋮ & ⋮ & ⋯ & ⋮ \\ {c}_{n − 1 , 0} & {c}_{n − 1 , 1} & & {c}_{n − 1 , m − 1}\end{matrix} ]\end{matrix} \qquad ( 8 - sd )$$

where γ is a normalization factor. In one example, W₁ is a joint SD-DD/TD basis. The quantities a_{s,d,-n+1} . . . , a_{s,d,-1}, a_{s,d,0}, a_{s,d,1}, . . . , a_{s,d,n-1} in (8-sd) can be configured to be determined by training an AI/ML model architecture. In another example, the quantities a_{s,d,-n+1} . . . , a_{s,d,-1}, a_{s,d,0}, a_{s,d,1}, . . . , a_{s,d,n-1} in (8-sd) can be configured from a candidate set of quantities. In another example, the quantities a_{s,d,-n+1} . . . , a_{s,d,-1}, a_{s,d,0}, a_{s,d,1}, . . . , a_{s,d,n-1} in (8-sd) can be specified.

In one embodiment, for the space, frequency, and temporal domains, the precoding matrix based on this disclosure has the following structure:

$$( 13 )$$

$$P = \frac{1}{γ} {W}_{1} {{W}_{2} ( {W}_{f} ⊗ {W}_{d} )}^{H} = \frac{1}{γ} {AC ( {A}_{f} ⊗ {A}_{d} )}^{H} = \frac{1}{γ} [ \begin{matrix}{a}_{0} & {a}_{− 1} & {a}_{− 2} & ⋯ & {a}_{− n + 1} \\ {a}_{1} & {a}_{0} & {a}_{− 1} & ⋱ & ⋮ \\ {a}_{2} & {a}_{1} & {a}_{0} & ⋱ & {a}_{− 2} \\ ⋮ & ⋱ & ⋱ & ⋱ & {a}_{− 1} \\ {a}_{n − 1} & ⋯ & {a}_{2} & {a}_{1} & {a}_{0}\end{matrix} ] ⋆ [ \begin{matrix}{c}_{0 , 0} & {c}_{0 , 1} & & {c}_{0 , mp − 1} \\ ⋮ & ⋮ & ⋯ & ⋮ \\ {c}_{n − 1 , 0} & {c}_{n − 1 , 1} & & {c}_{n − 1 , mp − 1}\end{matrix} ] ⋆ \begin{matrix} & {[ \begin{matrix}{a}_{f , 0} & {a}_{f , − 1} & {a}_{f , − 2} & ⋯ & {a}_{f , − m + 1} \\ {a}_{f , 1} & {a}_{f , 0} & {a}_{f , − 1} & ⋱ & ⋮ \\ {a}_{f , 2} & {a}_{f , 1} & {a}_{f , 0} & ⋱ & {a}_{f , − 2} \\ ⋮ & ⋱ & ⋱ & ⋱ & {a}_{f , − 1} \\ {a}_{f , m − 1} & ⋯ & {a}_{f , 2} & {a}_{f , 1} & {a}_{f , 0}\end{matrix} ]}^{H} ⊗ {[ \begin{matrix}{a}_{d , 0} & {a}_{d , − 1} & {a}_{d , − 2} & ⋯ & {a}_{d , − p + 1} \\ {a}_{d , 1} & {a}_{d , 0} & {a}_{d , − 1} & ⋱ & ⋮ \\ {a}_{d , 2} & {a}_{d , 1} & {a}_{d , 0} & ⋱ & {a}_{d , − 2} \\ ⋮ & ⋱ & ⋱ & ⋱ & {a}_{d , − 1} \\ {a}_{d , p − 1} & ⋯ & {a}_{d , 2} & {a}_{f , 1} & {a}_{d , 0}\end{matrix} ]}^{H}\end{matrix}$$

where γ is a normalization factor. In one example, W₁ is an SD basis (e.g. across P_{CSIRS} CSI-RS antenna ports), W_{f} is an FD basis, and W_{d} is a DD/TD basis. The quantities a₋ₙ₊₁ . . . , a₋₁, a₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (13) can be configured to be determined by training an AI/ML model architecture. In another example, the quantities a₋ₙ₊₁ . . . , a₋1, a₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (13) can be configured from a candidate set of quantities. In another example, the quantities a₋ₙ₊₁ . . . , a₋1, a₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (13) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] {C ( {A}_{f} ⊗ {A}_{d} )}^{H} \qquad ( 14 )$$

where γ is a normalization factor. In one example, W₁ is an SD basis for two antenna groups (e.g. two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$\begin{matrix}P = \frac{1}{γ} {W}_{1} {W}_{2} {W}_{f , d}^{H} = \frac{1}{γ} A C {A}_{f , d}^{H} = & \frac{1}{γ} [ \begin{matrix}{a}_{0} & {a}_{− 1} & {a}_{− 2} & ⋯ & {a}_{− n + 1} \\ {a}_{1} & {a}_{0} & {a}_{− 1} & ⋱ & ⋮ \\ {a}_{2} & {a}_{1} & {a}_{0} & ⋱ & {a}_{− 2} \\ ⋮ & ⋱ & ⋱ & ⋱ & {a}_{− 1} \\ {a}_{n − 1} & ⋯ & {a}_{2} & {a}_{1} & {a}_{0}\end{matrix} ] ⋆ [ \begin{matrix}{c}_{0 , 0} & {c}_{0 , 1} & & {c}_{0 , m − 1} \\ ⋮ & ⋮ & ⋯ & ⋮ \\ {c}_{n − 1 , 0} & {c}_{n − 1 , 1} & & {c}_{n − 1 , m − 1}\end{matrix} ] ⋆\end{matrix} \begin{matrix} & {[ \begin{matrix}{a}_{f , d , 0} & {a}_{f , d , − 1} & {a}_{f , d , − 2} & ⋯ & {a}_{f , d , − m + 1} \\ {a}_{f , d , 1} & {a}_{f , d , 0} & {a}_{f , d , − 1} & ⋱ & ⋮ \\ {a}_{f , d , 2} & {a}_{f , d , 1} & {a}_{f , d , 0} & ⋱ & {a}_{f , d , − 2} \\ ⋮ & ⋱ & ⋱ & ⋱ & {a}_{f , d , − 1} \\ {a}_{f , d , m − 1} & ⋯ & {a}_{f , d , 2} & {a}_{f , d , 1} & {a}_{f , d , 0}\end{matrix} ]}^{H}\end{matrix} \qquad ( 13 - fd )$$

where γ is a normalization factor. In one example, W₁ is an SD basis (e.g. across P_{CSIRS} CSI-RS antenna ports) and W_{f,d} is a joint FD-DD/TD basis. The quantities a₋ₙ₊₁ . . . , a₋1, a₀, a₁, . . . , aₙ₋₁ and/or a_{f,d,-m+1} . . . , a_{f,d,-1}, a_{f,d,0}, a_{f,d,1}, . . . , a_{f,d,m-1} in (13-fd) can be configured to be determined by training an AI/ML model architecture. In another example, the quantities a₋ₙ₊₁ . . . , a₋1, a₀, a₁, . . . , aₙ₋₁ and/or a_{f,d,-m+1} . . . , a_{f,d,-1}, a_{f,d,0}, a_{f,d,1}, . . . , a_{f,d,m-1} in (13-fd) can be configured from a candidate set of quantities. In another example, the quantities a₋ₙ₊₁ . . . , a₋1, a₀, a₁, . . . , aₙ₋₁ and/or a_{f,d,-m+1} . . . , a_{f,d,-1}, a_{f,d,0}, a_{f,d,1}, . . . , a_{f,d,m-1} in (13-fd) can be specified.

In a variation, the precoding matrix based on this disclosure has the following structure:

$$( 13 - sd )$$

$$P = \frac{1}{γ} {W}_{1} {W}_{2} {W}_{f}^{H} = \frac{1}{γ} {A}_{s , d} {CA}_{f}^{H} = \frac{1}{γ} [ \begin{matrix}{a}_{s , d , 0} & {a}_{s , d − 1} & {a}_{s , d , − 2} & ⋯ & {a}_{s , d , − n + 1} \\ {a}_{s , d , 1} & {a}_{s , d , 0} & {a}_{s , d , − 1} & ⋱ & ⋮ \\ {a}_{s , d , 2} & {a}_{s , d , 1} & {a}_{s , d , 0} & ⋱ & {a}_{s , d , − 2} \\ ⋮ & ⋱ & ⋱ & ⋱ & {a}_{s , d , − 1} \\ {a}_{s , d , n − 1} & ⋯ & {a}_{s , d , 2} & {a}_{s , d , 1} & {a}_{s , d , 0}\end{matrix} ] ⋆ [ \begin{matrix}{c}_{0 , 0} & {c}_{0 , 1} & & {c}_{0 , m − 1} \\ ⋮ & ⋮ & ⋯ & ⋮ \\ {c}_{n − 1 , 0} & {c}_{n − 1 , 1} & & {c}_{n − 1 , m − 1}\end{matrix} ] ⋆ {[ \begin{matrix}{a}_{f , 0} & {a}_{f , − 1} & {a}_{f , − 2} & ⋯ & {a}_{f , − m + 1} \\ {a}_{f , 1} & {a}_{f , 0} & {a}_{f , − 1} & ⋱ & ⋮ \\ {a}_{f , 2} & {a}_{f , 1} & {a}_{f , 0} & ⋱ & {a}_{f , − 2} \\ ⋮ & ⋱ & ⋱ & ⋱ & {a}_{f , − 1} \\ {a}_{f , m − 1} & ⋯ & {a}_{f , 2} & {a}_{f , 1} & {a}_{f , 0}\end{matrix} ]}^{H}$$

where γ is a normalization factor. In one example, W₁ is a joint SD-DD/TD basis and W_{f} is an FD basis. The quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (13-sd) can be configured to be determined by training an AI/ML model architecture. In another example, the quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (13-sd) can be configured from a candidate set of quantities. In another example, the quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (13-sd) can be specified.

In a variation, the precoding matrix based on this disclosure has the following structure:

$$P = \frac{1}{γ} {W}_{1} {W}_{2} = \frac{1}{γ} {A}_{s , f , d} C = \frac{1}{γ} [ \begin{matrix}{a}_{s , f , d , 0} & {a}_{s , f , d , - 1} & {a}_{s , f , d , - 2} & … & {a}_{s , f , d , - n + 1} \\ {a}_{s , f , d , 1} & {a}_{s , f , d , 0} & {a}_{s , f , d , - 1} & ⋱ & ⋮ \\ {a}_{s , f , d , 2} & {a}_{s , f , d , 1} & {a}_{s , f , d , 0} & ⋱ & {a}_{s , f , d , - 2} \\ ⋮ & ⋱ & ⋱ & ⋱ & {a}_{s , f , d , - 1} \\ {a}_{s , f , d , n - 1} & … & {a}_{s , f , d , 2} & {a}_{s , f , d , 1} & {a}_{s , f , d , 0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] \qquad ( 13 - sfd )$$

where γ is a normalization factor. In one example, W₁ is a joint SD-FD-DD/TD basis. The quantities a_{s,f,d,-n+1} . . . , a_{s,f,d-1}, a_{s,f,d,0}, a_{s,f,d,1}, . . . , a_{s,f,d,n-1} in (13-sfd) can be configured to be determined by training an AI/ML model architecture. In another example, the quantities a_{s,f,d,-n+1} . . . , a_{s,f,d-1}, a_{s,f,d,0}, a_{s,f,d,1}, . . . , a_{s,f,d,n-1} in (13-sfd) can be configured from a candidate set of quantities. In another example, the quantities a_{s,f,d,-n+1} . . . , a_{s,f,d-1}, a_{s,f,d,0}, a_{s,f,d,1}, . . . , a_{s,f,d,n-1} in (13-sfd) can be specified.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {W}_{1} {C ( {A}_{f} ⊗ {A}_{d} )}^{H} = \frac{1}{γ} {W}_{1} * [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H} \qquad ( 27 )$$

where γ is a normalization factor and W₁ corresponds to a different basis from W_{f} and W_{d} (e.g. the DFT basis that is used to perform SD compression in the Rel. 16 eType II codebook). In one example, W_{f} is an FD basis, and W_{d} is a DD/TD basis. The quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (27) can be configured to be determined by training an AI/ML model architecture. In another example, the quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (27) can be configured from a candidate set of quantities. In another example, the quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (27) can be specified.

In a variation, the precoding matrix based on this disclosure has the following structure:

$$P = \frac{1}{γ} {W}_{1} {W}_{2} {W}_{f , d}^{H} = \frac{1}{γ} {W}_{1} {CA}_{f , d}^{H} = \frac{1}{γ} {W}_{1} * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {[ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]}^{H} \qquad ( 27 - fd )$$

where γ is a normalization factor and W₁ corresponds to a different basis from W_{f,d} (e.g. the DFT basis that is used to perform SD compression in the Rel. 16 eType II codebook). In one example, W_{f,d} is a joint FD-DD/TD basis. The quantities a_{f,d,-m+1} . . . , a_{f,d,-1}, a_{f,d,0}, a_{f,d,1}, . . . , a_{f,d,m-1} in (27-fd) can be configured to be determined by training an AI/ML model architecture. In another example, the quantities a_{f,d,-m+1} . . . , a_{f,d,-1}, a_{f,d,0}, a_{f,d,1}, . . . , a_{f,d,m-1} in (27-fd) can be configured from a candidate set of quantities. In another example, the quantities a_{f,d,-m+1} . . . , a_{f,d,-1}, a_{f,d,0}, a_{f,d,1}, . . . , a_{f,d,m-1} in (27-fd) can be specified.

In one example, the training of a codebook components (e.g. basis W1) is according to one of the three types in Table 1.

TABLE 1

| | |
|---|---|
| Type 1: joint ENC-DEC training | No need for data sharing between gNB and UE |
| | (data shared with an OTT or 3^{rd} party server) |
| Type 2: simultaneous, but separate | Data sharing |
| ENC-DEC training | |
| Type 3: sequential, but separate | One-side needs to share (albeit small amount of) |
| ENC-DEC training | data other side, e.g. NW/gNB to UE |

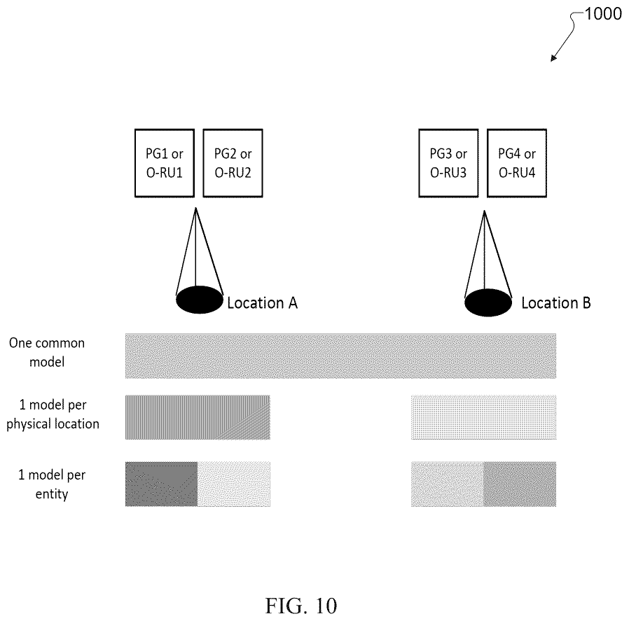

FIG. 10 illustrates a diagram of an example two-sided model 1000 according to embodiments of the present disclosure. For example, two-sided model 1000 can be implemented by the UE 116 and the gNB 102 and/or network 130 in the wireless network 100 of FIG. 1. This example is for illustration only and other embodiments can be used without departing from the scope of the present disclosure.

In one embodiment, for a UE (e.g., the UE 116) connected to N_{g}≥1 NW entities (an entity e.g. can be TRP, antenna panel, beam, port, TXRU, DU, RU, O-RAN O-RU, cell (serving, non-serving)), a model or UE-part of a two-sided model (comprising UE-part and NW-part) for a AI/ML- or deep-learning-based CSI report is fixed or configured or indicated (via DCI or MAC CE or vis system information such as SIB1) according to one of the following examples.

In one example, the number of models and their mapping to the entities are according to at least one of the following examples.
In one example, the model is fixed and common across entities (co-located (at one physical location) or non-co-located).
In one example, the model is fixed and common across entities that are co-located (at one physical location), and for non-co-located, from one site (physical location A) to another site (physical location B), the model can change (i.e. each site has its own model).
In one example, each entity has its own model regardless whether entities are co-located (at one physical location) or non-co-located.

These examples are illustrated in FIG. 10.

In one example, the model or UE-part of a two-sided model (comprising UE-part and NW-part) is for a first number of ports p₁, and that for a second (larger than p₁) number of ports p₂=k×p₁ where k∈{1, 2, 3, 4, . . . } is based on the model or UE-part of a two-sided model (comprising UE-part and NW-part) for the p₁ ports. For instance, using the model or UE-part of a two-sided model (comprising UE-part and NW-part) for p₁ ports k times can be one approach to apply the trained model for p₂ ports.

For example, when p₁=32 and p₂=64, there are two options as follows. In Option 1, the model training is based on 32-port data.
In one sub-option, reducing 64 port data to 32 port data for training is based on
   In one example, one half or group of ports (e.g. including both polarizations) is used
      In one example, the one half corresponds to ports (0-15, 32-47) or ports (0-31)·
In one example, two halves of 64 port data is used
   In one example, the two halves correspond to ports 0-31 and ports 32-63
   In one example, the two halves correspond to ports (ports 0-15 and 32-47) and (ports 16-31 and 48-63)
In one sub-option, there is no training for 64 port data; rather, a model M_32 for 32 ports is used for each of the halves. (according to one or more examples described herein)

In Option 2, the model training is based on 64-port data.
In one sub-option, there are 2 models, each for 32 ports (one of each half)
In one sub-option, there is one model.

In one embodiment, the model for a 1D basis (e.g. W₁ in SD or joint basis in SD and FD) is parameterized w.r.t. a 1D basis-related information. In one example, the information can be the size of the Kernel vector (L×1) where L is a length of the Kernel vector. In one example, the UE is configured with a Kernel or its parameter (e.g. via higher layer RRC, or via dynamic MAC CE or/and DCI indication). As example of supported set of values of L is shown in Table 2. For multiple layers (v>1),
In one example, the value of L can be rank-common, i.e. the common/same model for each rank values.
In one example, the value of L can be rank-specific, i.e. one value of L for each rank value

TABLE 2

| ParamCombination | Kernel size |
|---|---|
| 0 | (L₀, M₀) |
| 1 | (L₁, M₁) |
| 2 | (L₂, M₂) |
| . . . | . . . |

TABLE 3

| | Kernel size | | | |
|---|---|---|---|---|
| ParamCombination | | υ = 1 | υ = 2 | . . . |
| 0 | L₀ | M_{0,0} | M_{0,1} | |
| 1 | L₁ | M_{1,0} | M_{1,1} | |
| 2 | L₂ | M_{2,0} | M_{2,1} | |
| . . . | | . . . | | |

TABLE 4

| | Kernel size | | | |
|---|---|---|---|---|
| ParamCombination | | υ ϵ {1, 2} | υ ϵ {3, 4} | . . . |
| 0 | L₀ | M_{0,0} | M_{0,1} | |
| 1 | L₁ | M_{1,0} | M_{1,1} | |
| 2 | L₂ | M_{2,0} | M_{2,1} | |
| . . . | | . . . | | |

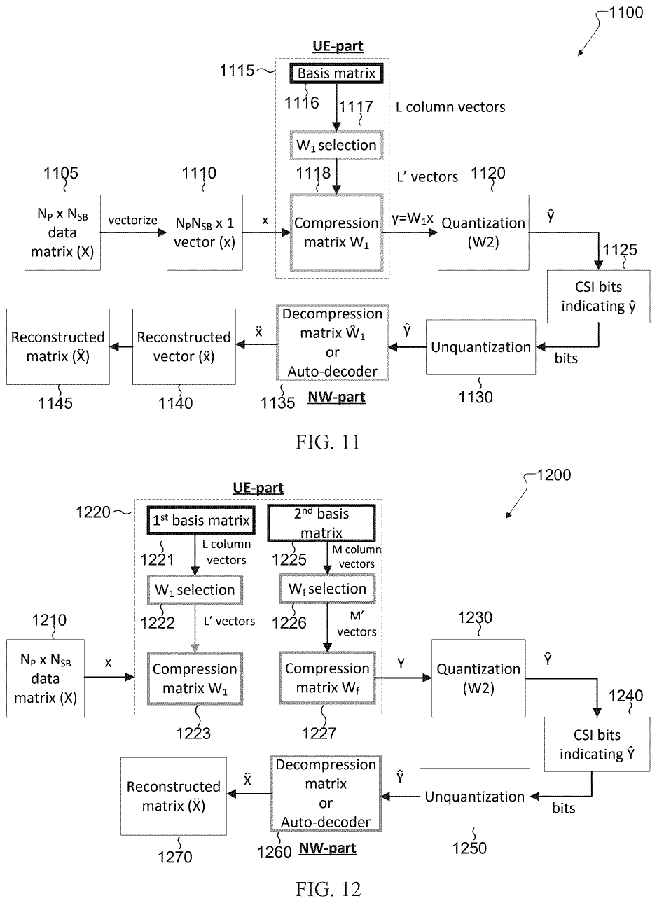

FIG. 11 illustrates a flowchart of an example procedure 1100 for parameterizing basis-related information according to embodiments of the present disclosure. For example, procedure 1100 can be performed by the UE 116 and the gNB 102 and/or network 130 in the wireless network 100 of FIG. 1. This example is for illustration only and other embodiments can be used without departing from the scope of the present disclosure.

The procedure begins in 1105, a (CSI) data matrix is provided. In 1110, the data matrix is vectorized and provided to a UE. In 1115, the UE-part is performed. The UE-part includes, in 1116, receiving a basis matrix; in 1117, selecting vectors from the basis matrix; and, in 1118, generating a compression matrix based on the vectors from 1110 and 1117. In 1120, the compression matrix in quantized. In 1125, the UE transmits CSI bits indicating the compression matrix. In 1130, the compression matrix is unquantized. In 1135, the NW decompresses the compression matrix. In 1140, reconstruction is performed on the vectors of the matrix. In 1145, reconstruction is performed on the matrix.

In one example, the information can be the size of the basis matrix (Z×L) where Z is dimension of the data, and L is a dimension (or number) of the Kernel or basis.
In one example, the basis matrix is in SD, and the value Z is based on P ports, e.g. Z=P or

$$Z = \frac{P}{2} .$$

In one example, the basis matrix is joint in SD and FD, and the value Z is based on P ports and N_{SB} SBs or N₃ FD units, e.g. Z=PN_{SB} or

$$Z = \frac{{PN}_{SB}}{2} or Z = {PN}_{3} or Z = \frac{{PN}_{3}}{2} .$$

The input data vectors {x} are multiplied with the basis matrix, the output {y} is quantized and reported by the UE as the CSI report. In one example, y=xW₁ where x is a row vector. In one example,

$$y = {W}_{1}^{H} x$$

where x is a column vector.

In one example, the UE is configured to receive the basis matrix (Z×L), as described herein, and select L′ vectors out of L columns of the basis matrix, where 1≤L′≤L. The selected L′ vectors comprise W₁. The information about this selection is reported by the UE (e.g. via an indicator such as PMI component i₁ or i_{1,x} where x is a number belonging to {0, 1, 2, . . . }). For instance, a length L bit sequence can be used for this purpose, where a bit value bᵢ=1 indicates selection of the i-th column of the basis matrix, and a bit value bᵢ=0 indicates that the i-th column of the basis matrix is not selected.

In one example, the value of L′ is fixed

$$( e . g . \frac{L}{2} )$$

or configured (e.g. via an RRC parameter or MAC CE or DCI codepoint). In this case, a combinatorial indicator taking a value from

$$\{ 0 , 1 , … , ( \begin{matrix}L \\ {L}^{′}\end{matrix} ) - 1 \}$$

and requiring

$$⌈ {log}_{2} ( \begin{matrix}L \\ {L}^{′}\end{matrix} ) ⌉$$

bits for reporting can be used.

This is illustrated in FIG. 11. The UE compresses the (CSI) data matrix as described herein, and reports the quantized output/coefficients to the NW. The NW-part unquantizes the received CSI bits, and performs decompression/reconstruction (e.g. using a reconstruction matrix or auto-decoder) in order to reconstruct the (CSI) data matrix.

In one embodiment, the model for a 2D basis (e.g. W1 in SD and Wf in FD) is parameterized w.r.t. a 2D basis-related information. In one example, the information can be the size of the Kernel matrix (L×M) where L is a number of rows and M is a number of columns of the Kernel. In one example, the UE is configured with a Kernel or its parameters (e.g. via higher layer RRC, or via dynamic MAC CE or/and DCI indication). For multiple layers (v>1),
In one example, same values for rank values. An example is shown in Table 2.
In one example, both L and M are specific for a rank value.
In one example, L is specific for a rank value, and M is rank-common.
In one example, M is specific for a rank value, and L is rank-common. An example is shown in Table 3.
In one example, M is specific for a rank pair, and L is rank-common. An example is shown in Table 4.

In one example, the information can be the size of the two basis matrices, first matrix of size (P×L) or

$$( \frac{P}{2} \times L )$$

and second matrix of size (N_{SB}, M) or (N₃, M) where P×N_{SB} or P×N₃ is dimension of the data matrix (e.g. eigenvectors across SBs), and L is a dimension (or number) of the Kernel or basis in SD, and M is a dimension (or number) of the Kernel or basis in FD.

The input data vectors {x} are multiplied with the basis matrix, the output {y} is quantized and reported by the UE as the CSI report. In one example,

$$Y = {W}_{f}^{H} {XW}_{1}$$

where X is the data matrix.

In one example,

$$Y = {W}_{1}^{H} {XW}_{f} .$$

In one example, the UE is configured to receive the first matrix of size (P×L) or

$$( \frac{P}{2} \times L ) ,$$

as described herein, and select L′ vectors out of L columns of the basis matrix, where 1≤L′≤L. The selected L′ vectors comprise W₁. The information about this selection is reported by the UE (e.g. via an indicator such as PMI component i_{1,1} or i_{1,x} where x is a number belonging to {0, 1, 2, . . . }). For instance, a length L bit sequence can be used for this purpose, where a bit value bᵢ=1 indicates selection of the i-th column of the basis matrix, and a bit value bᵢ=0 indicates that the i-th column of the basis matrix is not selected.

In one example, the value of L′ is fixed

$$( e . g . \frac{L}{2} )$$

or configured (e.g. via an RRC parameter or MAC CE or DCI codepoint). In this case, a combinatorial indicator taking a value from

$$\{ 0 , 1 , … , ( \begin{matrix}L \\ {L}^{′}\end{matrix} ) - 1 \}$$

and requiring

$$⌈ {log}_{2} {(}_{{L}^{′}}^{L} ) ⌉$$

bits for reporting can be used.

FIG. 12 illustrates a flowchart of an example procedure 1200 for parameterizing basis-related information according to embodiments of the present disclosure. For example, procedure 1200 can be performed by the UE 116 and the gNB 103 and/or network 130 in the wireless network 100 of FIG. 1. This example is for illustration only and other embodiments can be used without departing from the scope of the present disclosure.

The procedure begins in 1210, a (CSI) data matrix is provided to a UE. In 1220, the UE-part is performed. The UE-part includes, in 1221, receiving a first basis matrix; in 1222, selecting a first set of vectors from the first basis matrix; and in 1223, generating a first compression matrix based on 1210 and 1222. The UE-part further includes, in 1225, receiving a second basis matrix; in 1226, selecting a second set of vectors from the second basis matrix; and, in 1227, generating a second compression matrix based on 1210 and 1226. In 1230, the first and second compression matrices are quantized. In 1240, the UE transmits CSI bits indicating both compression matrices. In 1250, both compression matrices are unquantized. In 1260, the NW decompresses both compression matrices. In 1270, reconstruction is performed on both matrices.

In one example, the UE is configured to receive the second matrix of size (N_{SB}, M) or (N₃, M), as described herein, and select M′ vectors out of M columns of the basis matrix, where 1≤M′≤M. The selected M′ vectors comprise W_{f}. The information about this selection is reported by the UE (e.g. via an indicator such as PMI component i_{1,2} or i_{1,y} where y is a number belonging to {0, 1, 2, . . . }). For instance, a length M bit sequence can be used for this purpose, where a bit value bᵢ=1 indicates selection of the i-th column of the basis matrix, and a bit value bᵢ=0 indicates that the i-th column of the basis matrix is not selected.

In one example, the value of M′ is fixed

$$( e . g . \frac{M}{2} )$$

or configured (e.g. via an RRC parameter or MAC CE or DCI codepoint). In this case, a combinatorial indicator taking a value from

$$\{ 0 , 1 , … , {(}_{{M}^{′}}^{M} ) - 1 \}$$

and requiring

$$⌈ {log}_{2} {(}_{{M}^{′}}^{M} ) ⌉$$

bits for reporting can be used. In this case, a combinatorial indicator taking a value from

$$\{ 0 , 1 , … , {(}_{{M}^{′} - 1}^{M - 1} ) - 1 \}$$

and requiring

$$⌈ {log}_{2} {(}_{{M}^{′} - 1}^{M - 1} ) ⌉$$

bits for reporting can be used where it is expected that one of the M′ is fixed, e.g. to a 1^{st} column of the second basis matrix or the column corresponding to the one vector.

This is illustrated in FIG. 12. The UE compresses the (CSI) data matrix as described herein, and reports the quantized output/coefficients to the NW. The NW-part unquantizes the received CSI bits, and performs decompression/reconstruction (e.g. using a reconstruction matrix or auto-decoder) in order to reconstruct the (CSI) data matrix.

In one embodiment, the model for basis (e.g. W1) is parameterized w.r.t. basis-related information. In one example, the information can be the size of the Kernel matrix (L×M×D) where L is a number of units associated with a first dimension (e.g. SD), M is a number of units associated with a second dimension (e.g. FD), and D is a number of units associated with a third dimension (e.g. DD/TD). In one example, the UE is configured with a Kernel or its parameters (e.g. via higher layer RRC, or via dynamic MAC CE or/and DCI indication). For multiple layers (v>1),
In one example, values of L, M, and D are the same for rank values.
In one example, values of L, M, and D are specific for a rank value.
In one example, L is specific for a rank value, and (M, D) is rank-common.
In one example, (M, D) is specific for a rank value, and L is rank-common.
In one example, M is specific for a rank value, and (L, D) is rank-common.
In one example, (L, D) is specific for a rank value, and M is rank-common.
In one example, D is specific for a rank value, and (L, M) is rank-common.
In one example, (L, M) is specific for a rank value, and D is rank-common.

In one embodiment, the (non-zero) coefficients from the coefficient matrix/vector C (or y or Y) are quantized.
In one example, the quantization scheme is the same as in Rel-16 eType II codebook for amplitude and phase.
In one example, the quantization scheme is based on a uniform B bit quantizer, assuming the coefficients are real or real and imaginary parts (i.e. I/Q samples) are quantized separately.

In one embodiment, the data collection (based on the measurement at UE or/and gNB/RU/O-RU/PG) is according to at least one of the following examples.
In one example, the data collection is at a NW entity (e.g. O-CU, O-DU, or O-RU).
In one example, the data collection is at UE.
In one example, the data collection is at OAM (Operations, Administration, and Maintenance) which performs operations such as admin, maintenance.
In one example, the data collection is at OTT (over-the-top) server, which can be a 3^{rd} party application for running AI/ML algorithms (getting data, modeling, and validation).

In one embodiment, for the use case of CSI reporting (as explained herein), the measurement and data collection are according to one of the following examples.
In one example, the model training is @ NW based on measurement of an RS.
   In one example, the RS is at least one UL RS (e.g. SRS) measured by the NW (e.g. one or multiple O-RUs).
   In one example, the RS is at least one DL RS (e.g. NZP CSI-RS) measured by the UE, and the UE reports/provides the measurement data (CSI-RS measurement or CSI report) to NW (e.g. O-RU)
In one example, the model training is @ UE NW based on measurement of an RS.
   In one example, the RS is at least on DL RS (e.g. CSI-RS).
   In one example, the RS is at least on UL RS (e.g. SRS) and NW (O-RU) providing data (based on SRS measurement) to UE.

In one embodiment, for the use case of CSI reporting (as explained herein), the model is one-sided, i.e., one of encoder (ENC) and decoder (DEC). One side trains (e.g. W1) and transfers the model to the other side (e.g. offline).
In one example, the training is performed by NW and trained model is transferred to the UE.
In one example, the training is performed by UE and trained model is transferred to the NW.

In one embodiment, for the use case of CSI reporting (as explained herein), the model is two-sided, i.e. both ENC and DEC.
In one example, one side trains (e.g. NW or UE), keeps ENC and transfers DEC to the other side (e.g. offline).
In one example, each side trains its part, for example, the ENC side trains ENC and DEC side trains DEC.
   In one example, the training is performed by both NW and UE. For example, the ENC is trained at NW and DEC is trained at UE.

In one example, for a two-sided model, both sides (NW or UE) has the same (or same type of) model. In one example, for a two-sided model, two sides (NW or UE) can have their own model, implying the two models may be the same or different.

In one example, the model training can be performed offline (e.g., once) or online (e.g. multiple times). In one example, the training is offline for a static or pedestrian UE or fixed wireless access device (e.g. CSI). In one example, the training is online for UE (e.g., the UE 116) mobility and beam.

In one embodiment, the model is a convolutional NN (CNN) or a Transformer, and the training is one of or both of basis and coefficients of the dual-stage precoder.

A two-stage deep-learning precoding includes: (i) Stage 1 for set of basis entities (W1, Wf) or (W1, Wf, Wd) and (ii) Stage 2 for set of coefficients W2. There can be two assumptions regarding the antenna geometry/structure.
Assumption 1: it is dictated by spatial/frequency/time-domain (SD/FD/TD) properties, implying that a fixed codebook can suffice.
Assumption 2: it is agnostic to (SD, FD, TD) properties implying that there is a need for a learning-based (e.g. AI/ML, convolutional, non-DFT) codebook component.

Here, (SD, FD, TD) properties can depend on antenna geometry and 2nd order channel statistics etc.

Three examples of model type are shown in Table 5.

TABLE 5

| Example | Basis (W1, Wf, Wf) | W2 matrix |
|---|---|---|
| Example 1 | Fixed basis (e.g. DFT | Deep-learning based |
| | or Slepian) | |
| Example 2 | Deep-learning based | Fixed quantization |
| | | (CB-based) |
| Example 3 | Deep-learning based | Deep-learning based |

In Example 1, W1 is according to Assumption 1, implying that it can be CB-based, and W2 is according to Assumption 2, implying that it can be training-based (e.g. convolutional).
In Example 2, on the other hand, W1 is according to Assumption 2, implying that it can be learning-based e.g. Toeplitz (single, doubly), and W2 is according to Assumption 1, implying that it can be CB-based.
In Example 3, conversely, evaluates both W1 and W2 determination based on Assumption 1. One aspect here is W1 determination is cell/site-specific while W2 determination is cell/site/location agnostic, e.g., fully specified.

The typical (DFT-based) codebook can be used as fall-back and to initiate the precoding operation before switching to the leaning-based codebook.

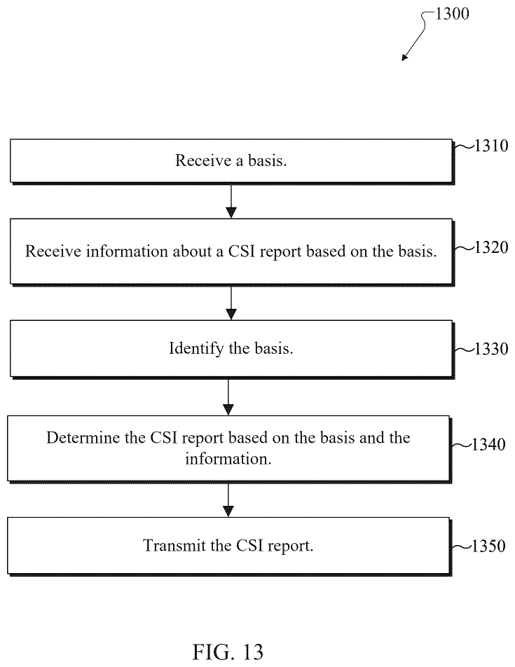

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE receiving a basis (1310). For example, in 1310, the basis is trained using data. In various embodiments, the data is based on at least one measurement RS and the at least one measurement RS is CSI-RS or SRS.

The UE then receives information about a CSI report based on the basis (1320). For example, in 1320, the information includes at least one parameter associated with the basis. The basis, the data, and the CSI report are associated with P ports and N_{SB} SBs. In various embodiments, the P ports are partitioned into N_{g} groups of ports, where N_{g}>1 and the basis includes a separate basis for each of the N_{g} groups of ports.

The UE then identifies the basis (1330). In various embodiments, the basis is a UE-side of a two-sided model comprising the UE-side and a NW-side. In various embodiments, the basis is a matrix and the at least one parameter indicates information about a size (Z×L) of the matrix, where Z is based on a size of the data and L is based on a size of the basis. In various embodiments, a value Z is based on PN_{SB} or

$$\frac{P {N}_{S B}}{2} .$$

In various embodiments, the UE selects L out of L columns of the matrix, where 1≤L′≤L and transmit an indicator indicating information about the selected L columns. In various embodiments, the indicator is a length-L bit sequence b₀ . . . b_{L-1}, where bᵢ=1 and bᵢ=0 indicates that an i-th column of the matrix is selected and not selected, respectively, or when a value of L′ is fixed or configured via RRC or MAC CE or DCI, a combinatorial indicator taking a value from

$$\{ 0 , 1 , … , {(}_{{L}^{′}}^{L} ) - 1 \}$$

and requiring

$$⌈ {log}_{2} {(}_{{L}^{′}}^{L} ) ⌉$$

bits.

The UE then determines the CSI report based on the basis and the information (1340). The UE then transmits the CSI report (1350).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a basis, wherein the basis is trained using data, and
receive information about a channel state information (CSI) report based on the basis, the information including at least one parameter associated with the basis; and
a processor operably coupled to the transceiver, the processor configured to:
identify the basis, and
determine the CSI report based on the basis and the information,
wherein the transceiver is further configured to transmit the CSI report, and
wherein the basis, the data, and the CSI report are associated with P ports and N_{SB} subbands (SBs).

2. The UE of claim 1, wherein:
the data is based on at least one measurement reference signal (RS), and
the at least one measurement RS is CSI-RS or sounding reference signal (SRS).

3. The UE of claim 1, wherein:
the P ports are partitioned into N_{g} groups of ports, where N_{g}>1, and
the basis includes a separate basis for each of the N_{g} groups of ports.

4. The UE of claim 1, wherein the basis is a UE-side of a two-sided model comprising the UE-side and a network (NW)-side.

5. The UE of claim 1, wherein:
the basis is a matrix, and
the at least one parameter indicates information about a size (Z×L) of the matrix, where Z is based on a size of the data and L is based on a size of the basis.

6. The UE of claim 5, wherein a value Z is based on PN_{SB} or
$$\frac{P {N}_{S B}}{2} .$$

7. The UE of claim 5, wherein:
the processor is further configured to select L′ out of L columns of the matrix, where 1≤L′≤L, and
the transceiver is further configured to transmit an indicator indicating information about the selected L′ columns.

8. The UE of claim 7, wherein the indicator is:
a length-L bit sequence b₀ . . . b_{L-1}, where bᵢ=1 and bᵢ=0 indicates that an i-th column of the matrix is selected and not selected, respectively, or
when a value of L′ is fixed or configured via radio resource control (RRC) or medium access control control element (MAC CE) or downlink control information (DCI), a combinatorial indicator taking a value from
$$\{ 0 , 1 , … , {(}_{{L}^{′}}^{L} ) - 1 \}$$
and requiring
$$⌈ {log}_{2} {(}_{{L}^{′}}^{L} ) ⌉$$
bits.

9. A base station (BS), comprising:
a processor; and
a transceiver coupled to the processor, the transceiver configured to:
transmit a basis, wherein the basis is trained using data, and
transmit information about a channel state information (CSI) report based on the basis, the information including at least one parameter associated with the basis; and
receive the CSI report that is associated with the basis and the information,
wherein the basis, the data, and the CSI report are associated with P ports and N_{SB} subbands (SBs).

10. The BS of claim 9, wherein:
the data is based on at least one measurement reference signal (RS), and
the at least one measurement RS is CSI-RS or sounding reference signal (SRS).

11. The BS of claim 9, wherein:
the P ports are partitioned into N_{g} groups of ports, where N_{g}>1, and
the basis includes a separate basis for each of the N_{g} groups of ports.

12. The BS of claim 9, wherein the basis is a user equipment (UE)-side of a two-sided model comprising the UE-side and a network (NW)-side.

13. The BS of claim 9, wherein:
the basis is a matrix, and
the at least one parameter indicates information about a size (Z×L) of the matrix, where Z is based on a size of the data and L is based on a size of the basis.

14. The BS of claim 13, wherein a value Z is based on PN_{SB} or
$$\frac{P {N}_{S B}}{2} .$$

15. The BS of claim 13, wherein:
the processor is further configured to select L′ out of L columns of the matrix, where 1≤L′≤L, and
the transceiver is further configured to transmit an indicator indicating information about the selected L′ columns.

16. The BS of claim 9, wherein the indicator is:
a length-L bit sequence b₀ . . . b_{L-1}, where bᵢ=1 and bᵢ=0 indicates that an i-th column of the matrix is selected and not selected, respectively, or
when a value of L′ is fixed or configured via radio resource control (RRC) or medium access control control element (MAC CE) or downlink control information (DCI), a combinatorial indicator taking a value from
$$\{ 0 , 1 , … , {(}_{{L}^{′}}^{L} ) - 1 \}$$
and requiring
$$⌈ {log}_{2} {(}_{{L}^{′}}^{L} ) ⌉$$
bits.

17. A method performed by a user equipment (UE), the method comprising:
receiving a basis, wherein the basis is trained using data;
receiving information about a channel state information (CSI) report based on the basis, the information including at least one parameter associated with the basis;
identifying the basis;
determining the CSI report based on the basis and the information; and
transmitting the CSI report,
wherein the basis, the data, and the CSI report are associated with P ports and N_{SB} subbands (SBs).

18. The method of claim 17, wherein:
the data is based on at least one measurement reference signal (RS), and
the at least one measurement RS is CSI-RS or sounding reference signal (SRS).

19. The method of claim 17, wherein:
the P ports are partitioned into N_{g} groups of ports, where N_{g}>1, and
the basis includes a separate basis for each of the N_{g} groups of ports.

20. The method of claim 17, wherein the basis is a UE-side of a two-sided model comprising the UE-side and a network (NW)-side.
